(19) United States
(12) Patent Application Publication
(10) Pub. No.: US 2022/0052897 A1
(43) Pub. Date: Feb. 17, 2022

(54) SELECTION SYSTEM FOR WAVEFORMS AND WAVEFORM PARAMETERS IN 5G AND BEYOND NEXT GENERATION COMMUNICATION SYSTEMS

(71) Applicant: ISTANBUL MEDIPOL UNIVERSITESI, Istanbul (TR)

(72) Inventors: Hüseyin ARSLAN, Istanbul (TR); Ahmet YAZAR, Istanbul (TR)

(21) Appl. No.: 17/413,768

(22) PCT Filed: May 13, 2020
(86) PCT No.: PCT/TR2020/050413

§ 371 Date: Jun. 14, 2021

(30) Foreign Application Priority Data
May 13, 2019 (TR) 2019/07154

(51) Int. Cl. H04L 27/26; H04W 48/18

(52) U.S. Cl. CPC H04L 27/26025; H04W 48/18; H04B 17/3912; H04L 27/2607; H04L 27/2646

(57) ABSTRACT

Disclosed are various strategies on general system optimization and selection of user parameters related to waveforms during the usage of multiple waveforms and/or multiple numerology structures in fifth generation (5G) and beyond next generation cellular communication systems.

### TECHNICAL FIELD

The invention consists of various strategies on general system optimization and selection of user parameters related to waveforms during the usage of multiple waveforms and/or multiple numerology structures in fifth generation (5G) and beyond next generation cellular communication systems.

### PRIOR ART

The fifth generation (5G) communication systems whose initial standards have been established and that are still being improved have been formed due to the requirement of higher levels of flexibility in comparison to prior cellular communication systems during the technology development phase. The increase of differences in terms of user and service requirements has led to the requirement of this flexibility. Together with the increased flexibility level of 5G communication systems, the numbers of parameters that are subject to communication between base stations and user equipment have also increased. A part of these parameters is related to a waveform.

The basis of communication between the transmitter and receiver during wireless communication is formed of a waveform design. Several parameters within the scope of the related techniques and waveform in 5G communication systems have been optionally left to be controlled by the network operator. It is possible to use multiple numerology structures that belong to a waveform in 5G communication systems. In post 5G cellular communication systems, however, the usage of multiple waveforms and multiple numerology structures together is being evaluated. This will bring about an increase in the number of parameters.

In the prior art, the number of studies in which the user parameters related to waveforms for 5G and beyond next generation wireless communication systems is automatically allowed to be selected by the base station and the number of studies where general system optimization is carried out accordingly is very low and a general strategy for such studies have not yet been developed.

The invention is related to establishing various strategies by means of traditional and novel, new general methods, on general system optimization and selection of user parameters related to waveforms during the usage of multiple waveforms and/or multiple numerology structures in fifth generation 5G and beyond next generation cellular communication systems.

### TECHNICAL PROBLEMS AIMED TO BE SOLVED BY THE INVENTION

The present invention consists of various strategies for selecting several user parameters and general system optimization related to the waveforms in 5G and beyond new generation cellular communication systems. The phases that may be encountered during the stages of selection of user parameters related to waveforms and the realization of optimizations directed to said selection at base stations have been contemplated and the details of said stages have been turned into strategies within the scope of the invention.

The selection of user parameters and the sub-components of the related optimization processes are important technical problems that must be handled. The sections of these sub-components that should be included in the optimization process need to be determined. Moreover, which one of all of the sub-components should be designed using traditional methods and which ones need to be carried out by new generation artificial intelligence-based methods such as machine learning or deep learning must be decided upon and this is another problem that needs to be tackled. Another important problem that has created a void in literature is how to create, the datasets, directed to the training of machine learning systems at points where new generation artificial intelligence based algorithms are used. Technical problems aimed to be solved by the invention are respectively, automatic selection of user parameters related to waveforms together with various optimization techniques, deciding which ones of the sub-components shall be created with traditional methods and which ones shall be created with new generation methods, developing techniques directed to creating datasets for the training of machine learning systems at points where new generation artificial intelligence based methods shall be used.

The structural and characteristic features and all of the advantages of the invention will be more clearly understood through the figures below and the detailed description written with reference to these figures; and for this reason, the evaluation should be made by taking these figures and detailed description into consideration.

### FIGURES DESCRIBING THE INVENTION

FIG. 1: View of the method diagram where the general system structure is not determined for optimization, but the user parameters related to waveform are directly determined.

FIG. 2: View of the method diagram where the user parameters related to waveform are determined following the determination of the general system structure for optimization.

FIG. 3: View of the method diagram where in the first step the user parameters related to waveform are determined approximately, then the general system structure for optimization is determined and following this the user parameters related to waveform are finally determined.

FIG. 4: View of the method diagram where in the first step the user parameters related with waveform are determined approximately or the general system structure for optimization is determined and following this the next determination process step is carried out and this cycle is repeated as many cycles as desired and in the last step the user parameters related with waveform are finally determined.

FIG. 5: View of the algorithm flow of the method for establishing wide datasets by way automatic class labeling and by way of taking different performance measures as basis intended for training of machine learning systems.

### REFERENCE NUMBERS FOR DESCRIBING THE INVENTION

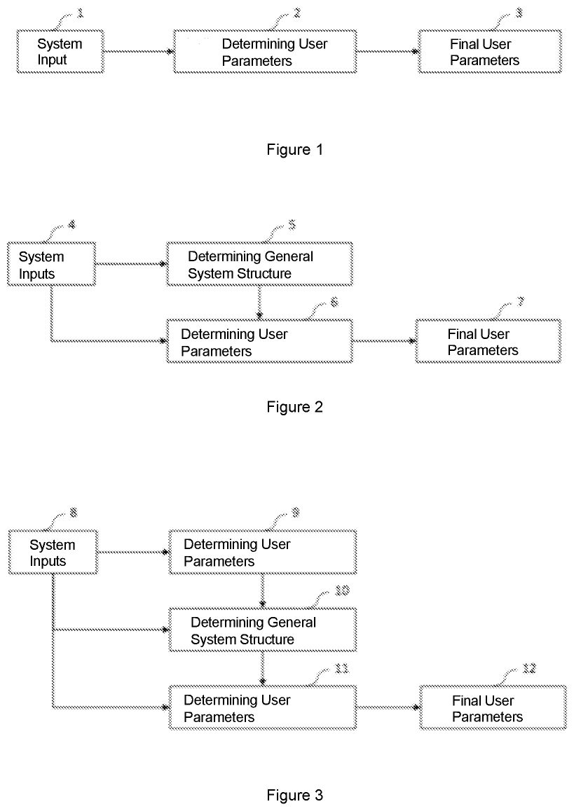

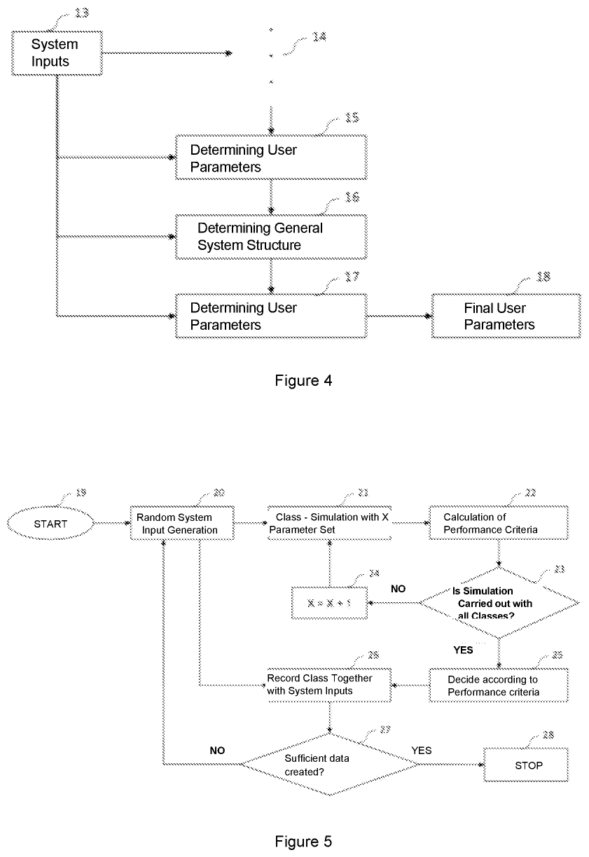

1. Block showing the system inputs for the method diagram in FIG. 1.
2. Algorithm block where the user parameters related to waveform are determined for the method diagram in FIG. 1.
3. Block for reaching the final user parameters as a system output for the method diagram in FIG. 1.
4. Block showing the system inputs for the method diagram in FIG. 2.
5. Algorithm block where the general system structure is determined for optimization, according to the method diagram in FIG. 2.
6. Algorithm block where the user parameters related to waveform are determined for the method diagram in FIG. 2.
7. Block for reaching the final user parameters as a system output for the method diagram in FIG. 2.
8. Block showing the system inputs for the method diagram in FIG. 3.
9. Algorithm block where the user parameters related to waveform are approximately determined for the method diagram in FIG. 3.
10. Algorithm block where the general system structure is determined for optimization, according to the method diagram in FIG. 3.
11. Algorithm block where the user parameters related to waveform are finally determined for the method diagram in FIG. 3.
12. Block for reaching the final user parameters as a system output for the method diagram in FIG. 3.
13. Block showing the system inputs for the method diagram in FIG. 4.
14. Algorithm block where the user parameters related to waveform are approximately determined for the method diagram in FIG. 4 and formation of the algorithm block at any desired numbers by repetition, where the general system structure for optimization is determined.
15. Algorithm block where the user parameters related to waveform are determined for the last time, for the method diagram in FIG. 4.
16. Algorithm block where the general system structure is determined for optimization for the last time, according to the method diagram in FIG. 4.
17. Algorithm block where the user parameters related to waveform are finally determined for the method diagram in FIG. 4.
18. Block for reaching the final user parameters as a system output for the method diagram in FIG. 4.
19. Block that starts the algorithm flow for situations where the dataset needs to be formed.
20. Block where the random system input production in an algorithm that forms the dataset is carried out.
21. Block where a simulation is carried out with a certain class label in an algorithm that forms the dataset.
22. Block where the performance criteria are calculated as a result of the simulation carried out on an algorithm that forms the dataset.
23. Block that controls if the simulation for all class labels in an algorithm that forms the dataset has been carried out or not.
Block that allows passage to different class labels in an algorithm that forms the dataset.
24. Block where the class label that provides the best result according to performance criteria in an algorithm forming the dataset is selected.
25. Block in which the most suitable class label corresponding to the system inputs and the system inputs that have been randomly produced in an algorithm that forms the dataset are recorded into the dataset.
26. Block that controls that a sufficient number of data is created in the algorithm that forms the dataset.
27. Block that ends the algorithm flow for the algorithm that forms the dataset.

### DETAILED DESCRIPTION OF THE INVENTION

The subject of the invention consists of various strategies on general system optimization and selection of user parameters related to waveforms during the usage of multiple waveforms and/or multiple numerology structures in 5G and beyond next generation cellular communication systems. Four basic structures have been formed in order to reach this aim. Following this, different strategies that can be fictionalized under these basic structures have been described.

In the method diagram shown in FIG. 1, the user parameters are directly determined (2) by means of the system inputs (1) that are formed of different types of information such as channel status information received from users or user service type information; however, the general system structure for optimization is not taken into consideration. The final user parameters (3) related to waveform, are obtained in a single step. The most important advantage of this method is that the calculation is not at a high level of complexity. Parameter assignment is carried out for each user in this method diagram, concerning the waveform independent from other users.

In the method diagram shown in FIG. 2, the system inputs (4) that are created from different types of information such as channel status information received from users or user service type information are used primarily to determine (5) the general system structure for optimization. At this stage, decisions regarding the general system structure are taken and some restrictions may be applied during the determination (6) of final user parameters related to waveform. By means of these restrictions, in the case that sufficient resources for completely responding to the requests of each user is not available at network operators, the general system quality can be further protected. The final user parameters (7) related to waveform, are obtained in two steps in this method diagram.

In the method diagram shown in FIG. 3 the system inputs (8) that are created from different types of information such as channel status information received from users or user service type information, are used primarily to approximately determine (9) the user parameters related to waveform. It has been aimed for the user parameters related to waveform that have been determined in this step, to be able to be changed in order to increase general system quality in further steps. By using the results obtained in the first step, it is enabled for the decisions (10) related to the general system structure given in the second step to be more accurate. In the second step, decisions (10) regarding the general system structure for optimization are taken and some restrictions may be applied at the third step, during the determination (11) of final user parameters related to waveform. By means of these restrictions, in the case that sufficient resources for completely responding to the requests of each user is not available at network operators, the general system quality can be further protected. The final user parameters (12) related to waveform, are obtained in three steps in this method diagram.

In the method diagram shown in FIG. 4 the system inputs (13) that are created from different types of information such as channel status information received from users or user service type information, can be used optionally to approximately determine the user parameters related with waveform or to determine the general system structure for optimization. If the first step is started as determining the user parameters related to waveform the next step shall be continued as determining the general system structure for optimization. On the contrary, the step will be continued with the step of determining approximately the user parameters related to waveform. The flow of the method diagram is continued by, passing (14) to and fro at any desired number between these two structures. As the number of passages is increased the ideal solution according to the network operator shall be approached. Together with this, calculation complexity may somewhat increase. After the final determination (15) of the waveform related user parameters for the last time, for the purpose of optimization, the general system structure will be determined (16) again for the last time and some restrictions may be applied for the last time during the determination (17) of the final user parameters related with waveform. The final user parameters (18) related to waveform, are obtained in at least four steps in this method diagram.

The user parameters related to waveforms that are obtained using the method diagrams described in detail above, can encompass parameters such as numerology type for the orthogonal frequency division multiplexing (OFDM) waveforms, subcarrier block, symbol length, cyclic prefix length, slot numbers, filtering type and coefficients, and framing length. Also, many different user parameters for both OFDM and different waveforms are included in this scope.

There are basically two main blocks of algorithms in the method diagrams, the details of which are described. The first one is the selection of user parameters related to the waveform and the other is general system optimization. As one of the strategies subject of the present invention, the distribution of the workload can be distributed in different weights between these two main algorithm blocks. For example, in the method diagram shown in FIG. 2, at the step of determining (5) the general system structure the number of different numerologies to be used by the base station at that moment is determined and in the step of selecting (6) the user parameters, the number to be assigned to the user shall be able to be determined by taking into consideration the limitation reached in the first step. In this example, as an alternative, at the step of determining (5) the general system structure, the numerologies that can be used by the base station at that moment could also have been decided. In such a case a more specific limitation would have been brought about and the workload of the first step would have been increased. In the second step, the suitable numerology for each user from a limited numerology set could have been selected. As can be seen in these examples, the selection (6) of user parameters and general system optimization (5) thereof can be adjusted according to the preference of workload distribution between algorithm blocks. It is possible to develop different designs for different scenarios.

One of the important factors during the adjustment of workload distribution between main algorithm blocks is to decide which of the sub-components that shall be used in algorithm blocks will be formed by traditional and which shall be formed by new generation methods. New generation methods such as machine learning may supersede traditional methods in some situations; however, the contrary is also possible. Sometimes the success rates are the same. In such cases, the decision must be taken by taking the calculation complexity criteria as basis. For example, when the method diagram shown in FIG. 3 is taken into consideration, while traditional methods are preferred when determining (9) the user parameters related with the waveform at the first step, in the next step, new generation method such as machine learning can be preferred for general system optimization (10). In the final step, again traditional methods can be used to determine final user parameters (11). As it can be seen from this example, traditional methods and new generation methods can be used together. At this point, a result should be obtained by enabling automatic selection of user parameters together with various optimization techniques and by taking into account the decisions that are given for workload distribution between the main algorithm blocks. Different designs need to be developed for different scenarios based on performance criteria. Techniques need to be developed directed to forming datasets for training of machine learning systems at the points where new generation artificial intelligence based methods shall be used. Datasets that can be used to select user parameters related to waveform are not available in literature. As a part of the strategies subject to this invention, a dataset can be formed in relation to training of machine learning systems which depend on computer simulation.

After the dataset formation algorithm is started (19) based on computer simulation as shown in FIG. 5, different user information can be obtained by means of random system input generation (20). For this information, an appropriate algorithm cycle is created so that all class labels can be simulated (21) respectively. The performance criteria (22) are calculated for each simulation and the results are stored. Each time, it is checked (23) whether or not a simulated has been carried out for all class labels. It is enabled for performance criteria calculations (22) to be obtained for all different class labels by switching to (24) different class labels. The class label that gives the best result following computer simulation according to performance criteria is selected (25). Datasets are continued to be formed following the recording (26) of system inputs and the most suitable label corresponding to these inputs. After it is checked (27) if sufficient data is generated or not, the algorithm is stopped (28) at the last step. Numerous data may be required during the creation of datasets for new generation methods similar to deep learning. The amount of that data needs to be generated is decided according to different situations.

The process steps of said method diagram and strategies are as follows:
It is accepted that the waveforms that can be used in services to be given to users within the coverage area of the base station, and that all kinds of user parameters related to these waveforms are defined to the base station.
A system design is determined such that the number of algorithm blocks (2) (6) (9) (11) (15) (17) that select the user parameters related to waveform and the number of algorithm blocks (5) (10) (16) that provide general system optimization and also the number of repetitions are decided,
The selection of the user parameters related to waveform of the system inputs (1) (4) (8) (13) that can be related with the users and the relevant service types and general system optimization is sent to each one of the blocks,
If more than one of the algorithm blocks that select, user parameters related to waveform are to be used, those besides the last block (where the final user parameters are determined) in the repetition row are used in order to approximately determine parameters,
It is made possible to provide services with multiple numerologies (parameters belonging to a waveform) and multiple waveforms at the same time to different users by base stations and therefore it is also enabled to carry out general system optimization within this scope,
The reduction of high service quality is tried to be prevented by means of general system optimization, where said reduction in quality may be caused by scarce resources of a network operator during meeting of user requirements,
The user parameters related to waveform encompasses parameters such as numerology type for the orthogonal frequency division multiplexing (OFDM) waveforms, subcarrier block, symbol length, cyclic prefix length, slot numbers, filtering type and coefficients, and framing length and several different user parameters are included within this scope for both OFDM and other different waveforms,
As it can be seen in these examples, the selection (2) (6) (9) (11) (15) (17) of user parameters and general system optimization (5) (10) (16) thereof can be adjusted according to the preference of workload distribution between algorithm blocks, and different designs can be developed for different scenarios,
Various performance criteria are taken as basis in order to decide which one of the subcomponents that shall be used in algorithm blocks during the adjustment of workload distribution between main algorithm blocks shall be created by means of traditional methods and which ones shall be created by means of new generation methods,
Computer simulation shall be used in order to develop techniques that are directed to forming datasets for the training of machine learning systems at the points where new generation artificial intelligence-based methods, shall be used,
Different user information is obtained, primarily via the random system input generation (20) by means of a dataset generation algorithm based on computer simulation,
For this user information, an appropriate algorithm cycle is created so that all class labels can be simulated (21) respectively,
The performance criteria (22) are calculated for each simulation and the results are stored,
Each time, it is checked (23) whether or not a simulated has been carried out for all class labels,
It is enabled for performance criteria calculations (22) to be obtained for all different class labels by switching to (24) different class labels,
The class label that gives the best result following computer simulation according to performance criteria is selected (25),
Datasets are continued to be formed following the recording (26) of system inputs and the most suitable label corresponding to these inputs,
After it is checked (27) if sufficient data is generated or not, the algorithm is stopped (28) at the last step,
As several numbers of data are required during the creation of a dataset for new generation methods such as deep learning, the number of data to be produced under different circumstances is decided,
The usage of traditional methods and new generation methods are made possible, while automatic selection of user parameters together with various optimization techniques and the workload distribution between the main algorithm blocks are decided upon,
At the final step, the final user parameters related to waveform are determined.

The technical and other features mentioned in each claim are followed by a reference number, and these reference numbers have been used in order to make it easier to understand the claims; therefore it should be noted that none of the elements mentioned together with these reference numbers that have been given for illustration should be deemed to limit the scope of the invention.

Around these basic concepts, it is possible to develop several embodiments regarding the subject matter of the invention; therefore the invention cannot be limited to the examples disclosed herein, and the invention is essentially as defined in the claims.

It is obvious that a person skilled in the art can convey the novelty of the invention using similar embodiments and/or that such embodiments can be applied to other fields similar to those used in the related art. Therefore it is also obvious that these kinds of embodiments are void of the novelty criteria and the criteria of exceeding the known state of the art.

### INDUSTRIAL APPLICATION OF THE INVENTION

By integrating the method diagrams and strategies subject to the invention into base stations of the new generation cellular communication systems, the most efficient allocation of radio sources will be provided by the successful selection of user parameters related to the waveform during the usage of multiple waveform and/or multiple numerology structures.

1. A method on the selection of user parameters related to waveforms in 5G and beyond next generation cellular communication systems and on general system optimization in this aspect, characterized by:
accepting that the waveforms that can be used in services to be given to users within the coverage area of the base station, and that all kinds of user parameters related to these waveforms are defined to the base station;
determination of a system design such that the number of algorithm blocks (2) (6) (9) (11) (15) (17) that select the user parameters related to waveform and the number of algorithm blocks (5) (10) (16) that provide general system optimization and also the number of repetitions are decided for the given system;
selection of the user parameters related to waveform of the system inputs (1) (4) (8) (13) that can be related with the users and the relevant service types and sending them to each one of the general system optimization blocks;
usage of the parameters besides those in the last block (where the final user parameters are determined) in the repetition row in order to approximately determine parameters, if more than one of the algorithm blocks that select, user parameters related to waveform are to be used;
making it possible to provide services with multiple numerologies (parameters belonging to a waveform) and multiple waveforms at the same time to different users by base stations and therefore enabling to carry out general system optimization within this scope;
avoiding the reduction of high service quality by means of general system optimization, where said reduction in quality may be caused by scarce resources of a network operator during, meeting user requirements; and
the user parameters related to waveform, encompassing parameters such as numerology type for the orthogonal frequency division multiplexing (OFDM) waveforms, subcarrier block, symbol length, cyclic prefix length, slot numbers, filtering type and coefficients, and framing length and several different user parameters being included within this scope for both OFDM and other different waveforms.

2. A method according to claim 1, wherein the selection (2) (6) (9) (11) (15) (17) of user parameters and general system optimization (5) (10) (16) thereof can be adjusted according to the preference of workload distribution between algorithm blocks, and different designs can be developed for different scenarios.

3. A method according to claim 1, wherein various performance criteria are taken as basis in order to decide which one of the subcomponents that shall be used in algorithm blocks during the adjustment of workload distribution between main algorithm blocks shall be created by means of traditional methods and which ones shall be created by means of new generation methods.

4. A method according to claim 1, comprising the following process steps:
computer simulation shall be used in order to develop techniques that are directed to forming datasets for the training of machine learning systems at the points where new generation artificial intelligence-based methods, shall be used;
different user information is obtained, primarily via the random system input generation (20) by means of a dataset generation algorithm based on computer simulation;
for user information, an appropriate algorithm cycle is created so that all class labels can be simulated (21) respectively;
the performance criteria (22) are calculated for each simulation and the results are stored;
each time, it is checked whether or not a simulation has been carried out for all class labels;
it is enabled for performance criteria calculations (22) to be obtained for all different class labels by switching to (24) different class labels;
the class label that gives the best result following computer simulation according to performance criteria is selected (25);
datasets are continued to be formed following the recording (26) of system inputs and the most suitable label corresponding to these inputs;
after it is checked (27) if sufficient data is generated or not, the algorithm is stopped (28) at the last step; and
as several numbers of data are required during the creation of a dataset for new generation methods such as deep learning, the number of data to be produced under different circumstances is decided.

5. A method according to claim 1, wherein while the usage of traditional methods and new generation methods are made possible, the automatic selection of user parameters together with various optimization techniques and the workload distribution between the main algorithm blocks are taken into consideration.

6. A method according to claim 1, characterized in that at the final step, the final user parameters related to waveform are determined.
